(19) United States
(12) Patent Application Publication
(10) Pub. No.: US 2016/0353813 A1
(43) Pub. Date: Dec. 8, 2016

(54) GARMENT ASSEMBLY HAVING LIGHT-REFLECTIVE ELEMENT AND LIGHT-EMITTING ELEMENT

(71) Applicant: Robert Colin RAE, Lake Country (CA)

(72) Inventor: Robert Colin RAE, Lake Country (CA)

(21) Appl. No.: 14/732,902

(22) Filed: Jun. 8, 2015

(51) Int. Cl. A41D 13/01; A41D 1/00; A41D 1/04; F21V 33/00; F21V 7/00

(52) U.S. Cl. CPC A41D 13/01; F21V 33/0008; F21V 7/0066; A41D 1/04; A41D 1/002; F21Y 2103/003

(57) ABSTRACT

An apparatus includes a garment assembly and a light-reflective element mounted to the garment assembly. A light-emitting element is configured to be mounted to the garment assembly relative to the light-reflective element.

### TECHNICAL FIELD

This document relates to the technical field of (and is not limited to) an apparatus including a garment assembly, a light-reflective element and a light-emitting element.

### BACKGROUND

High-visibility clothing (such as a safety vest) is a type of personal protective equipment. High-visibility clothing is clothing (worn by a user) that has highly reflective properties or a color that is easily discernible from a background. Yellow waistcoats worn by emergency services personnel are a common example. Occupational wearers of clothing with high-visibility features include railway and highway workers, airport workers or other individuals who work near moving vehicles. Some cyclists wear high-visibility clothing when riding amongst motor vehicles. Hunters wear high-visibility clothing to prevent accidental shooting.

### SUMMARY

It will be appreciated that there exists a need to mitigate (at least in part) at least one problem associated with the existing garments (also called the existing technology). After much study of the known systems and methods with experimentation, an understanding of the problem and its solution has been identified and is articulated as follows:

For instance, tow truck drivers wear safety vests to improve their personal safety while on the job. It is very dangerous for tow truck drivers to provide service to vehicles stranded on the side of a highway. Sometimes, it is difficult to see these workers even for the case where they wear safety vests that have a light-reflective material mounted to the safety vest.

What is needed is a user garment to be worn by a user, in which the user garment is configured to make the user even more visible to other people, and (in this way) safety to the user is improved, at least in part, during the daytime hours and/or during the nighttime hours.

To mitigate, at least in part, at least one problem associated with the existing technology, there is provided (in accordance with a major aspect) an apparatus. The apparatus includes a garment assembly and a light-reflective element mounted to the garment assembly. A light-emitting element is configured to be mounted to the garment assembly relative to the light-reflective element.

To mitigate, at least in part, at least one problem associated with the existing technology, there is provided (in accordance with a major aspect) an apparatus. The apparatus is for a user. The apparatus includes a garment assembly configured to be worn by the user. A light-reflective element is mounted to the garment assembly. The light-reflective element is configured to receive light having many frequencies. The light-reflective element is also configured to reflect, in use and at least in part, the light having many frequencies along a direction that is aligned away from the garment assembly. A light-emitting element is configured to emit a light in response to the application of electrical energy (to the light-emitting element), and to be mounted to the garment assembly relative to the light-reflective element. The light-emitting element is also configured to be positioned, once mounted just so, proximate to the light-reflective element in such a way that some of the light that is emitted by the light-emitting element is reflected by the light-reflective element along the direction that is aligned away from the garment assembly.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 (SHEET 1 of 5 SHEETS) depicts a front view of an embodiment of an apparatus including a garment assembly, a light-reflective element and a light-emitting element;

FIG. 2A and FIG. 2B (SHEET 2 of 5 SHEETS) depict views of embodiments of the apparatus of FIG. 1;

FIG. 3A, FIG. 3B and FIG. 3C (SHEET 3 of 5 SHEETS) depict views of embodiments of the apparatus of FIG. 1;

FIGS. 4A to 4F (SHEET 4 of 5 SHEETS) depict views of embodiments of the apparatus of FIG. 1; and

FIGS. 5A to 5F (SHEET 5 of 5 SHEETS) depict views of embodiments of the apparatus of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 garment assembly
104 light-reflective element
106 light-emitting element
107 light
108 remote control device
900 user

### DETAILED DESCRIPTION OF THE EXEMPLARY EMBODIMENTS

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

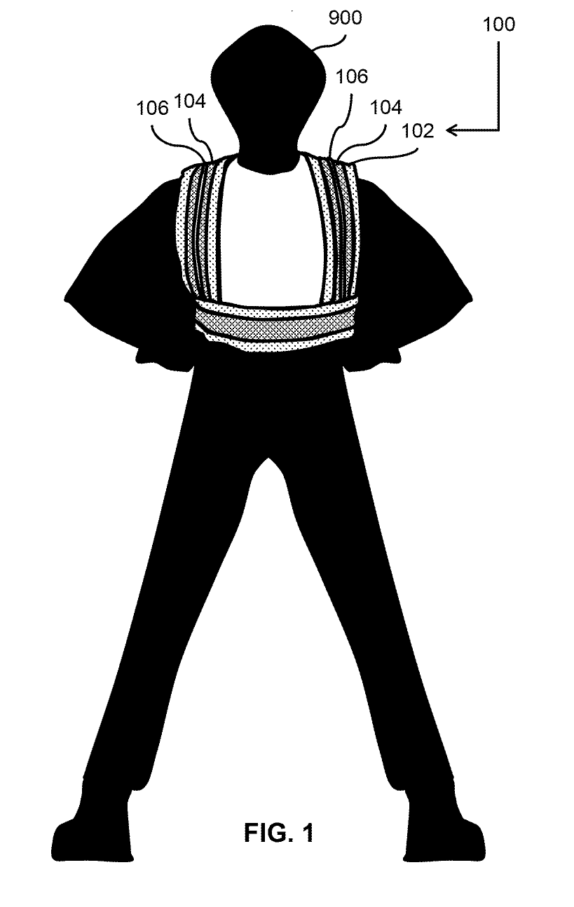

FIG. 1 (SHEET 1 of 5 SHEETS) depicts a front view of an embodiment of an apparatus 100 including a garment assembly 102, a light-reflective element 104 and a light-emitting element 106.

In accordance with a first major embodiment, the apparatus 100 includes (and is not limited to) the garment assembly 102 and the light-reflective element 104 mounted to the garment assembly 102. The light-emitting element 106 is configured to be mounted to the garment assembly 102 relative to the light-reflective element 104. A technical effect of the apparatus 100 is that the apparatus 100 sheds (provides) more light to viewers of the apparatus 100, thereby improving the safety of the user 900 (once the user wears the apparatus 100 and the light-emitting element 106 is energized to emit light). The light-reflective element 104 may be called a light-reflective tape band.

In accordance with a second major embodiment, the apparatus 100 is for a user 900. The apparatus 100 includes the synergistic combination of the garment assembly 102, the light-reflective element 104 and the light-emitting element 106. The garment assembly 102 is configured to be worn (directly or indirectly) by the user 900. The garment assembly 102 may be worn over the clothing of the user 900 or may be worn directly on the user 900 (if so desired). The garment assembly 102 may be called a vest assembly. The light-reflective element 104 is mounted (directly or indirectly) to the garment assembly 102. The light-reflective element 104 is configured to receive light having many frequencies. The light-reflective element 104 is also configured to reflect, in use and at least in part, the light having many frequencies along a direction that is aligned away from the garment assembly 102. The light-emitting element 106 is configured to emit a light in response to the application of electrical energy (to the light-emitting element 106). The light-emitting element 106 is also configured to be mounted (directly or indirectly) to the garment assembly 102 relative to the light-reflective element 104. The light-emitting element 106 is also configured to be positioned, once mounted just so, proximate to the light-reflective element 104. This is done in such a way that some of the light that is emitted by the light-emitting element 106 is reflected by the light-reflective element 104 along the direction that is aligned away from the garment assembly 102. A technical effect of the apparatus 100 is that the apparatus 100 sheds (provides) more light to viewers of the apparatus 100, thereby improving the safety of the user 900 (once the user wears the apparatus 100 and the light-emitting element 106 is energized to emit light). Another technical effect is that the apparatus 100 may be relatively brighter in daytime lighting conditions and/or nighttime lighting conditions.

In accordance with an option, the garment assembly 102 is configured to be worn on the upper half (such as, the chest region) of the body of the user 900.

The garment assembly 102 is configured to provide a built-in pocket configured to receive and support a cell phone, a remote control, etc., any any equivalent thereof. Preferably, the garment assembly 102 is made of a fire retardant material. In accordance with an option, the light-reflective element 104 includes a strip of material configured to reflect light. The light-reflective element 104 may include different colors (two or more colors).

In accordance with an option, the light-emitting element 106 includes a strip of LEDs (light-emitting diodes). In accordance with an option, the light-emitting element 106 includes a ribbon-like strip of surface-mounted light-emitting diodes. The ribbon-like strip is affixed (such as, sewn, glued, or welded, etc., and any equivalent thereof) to the garment assembly 102 on top of the reflective tape band that is attached (such as, sewn, etc., and any equivalent thereof) to the garment assembly 102. Preferably, the light-emitting element 106 (also called, light-emitting ribbon strips) has a silicone face which makes the light-emitting element 106 shockproof and/or waterproof. The light-emitting element 106 includes light-emitting diodes (placed along a row) that are bonded in silicone. A technical effect of this arrangement is that the light-emitting element 106 is shockproof and/or waterproof. The light-emitting element 106 includes a control device (control chip) on board. The light-emitting element 106 includes light-emitting diodes that are any one of multi-colored light-emitting diodes (LEDs) and single colored light-emitting diodes. The light-emitting element 106 includes LEDs that are surface mounted LEDs.

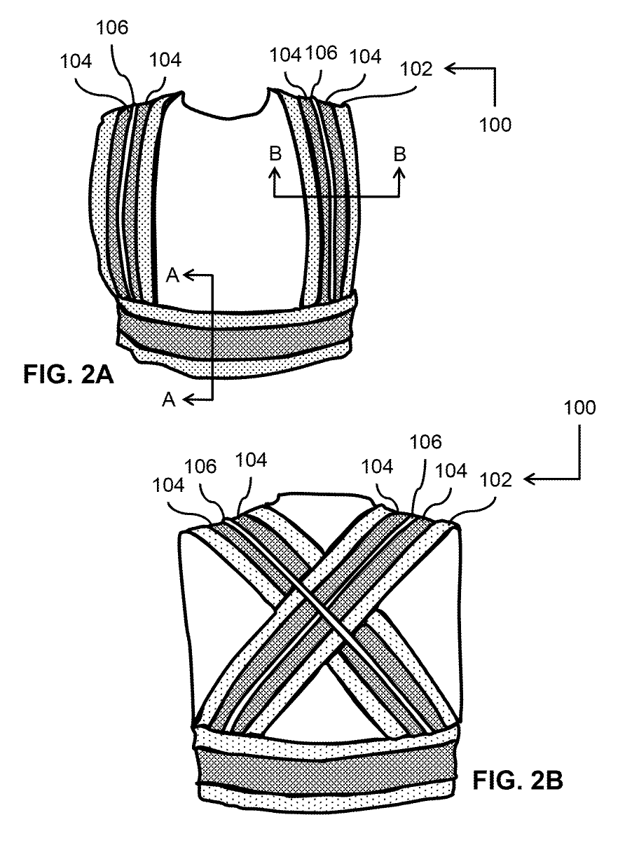

FIG. 2A and FIG. 2B depict views of embodiments of the apparatus 100 of FIG. 1. FIG. 2A depicts a front view of an embodiment of the apparatus 100. FIG. 2B depicts a rear view of an embodiment of the apparatus 100.

Referring to the embodiment depicted in FIG. 2A, the light-emitting element 106 and the light-reflective element 104 are positioned on the front side of the garment assembly 102, at the opposite sides of the garment assembly 102 proximate to the arms of the user 900.

Referring to the embodiment depicted in FIG. 2B, the light-emitting element 106 and the light-reflective element 104 are positioned on the rear side of the garment assembly 102 in such a way that the light-emitting element 106 and the light-reflective element 104 form an X-pattern that is positioned at a central portion of the rear of the garment assembly 102.

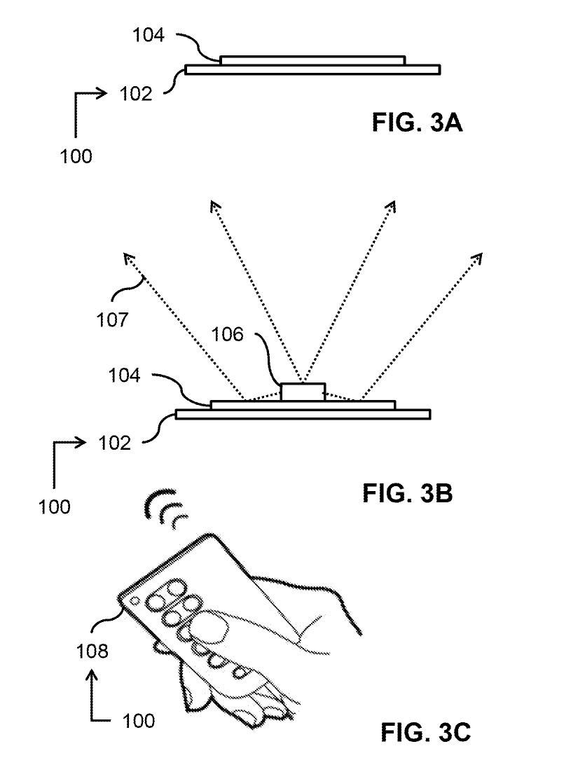

FIG. 3A and FIG. 3B depict cross-sectional views of embodiments of the apparatus 100 of FIG. 1. FIG. 3A depicts a cross-sectional view of an embodiment of the apparatus 100 taken along a cross-sectional line A-A of FIG. 2A. FIG. 3B depicts a cross-sectional view of an embodiment of the apparatus 100 taken along a cross-sectional line B-B of FIG. 2A.

Referring to the embodiment depicted in FIG. 3A, the garment assembly 102 includes the light-reflective element 104 without the light-emitting element 106 mounted on the light-reflective element 104. Referring to the embodiment depicted in FIG. 3B, the garment assembly 102 includes the light-reflective element 104 with the light-emitting element 106 mounted on the light-reflective element 104. The light 107 is emitted by the light-emitting element 106, and is then reflected by the light-reflective element 104 along a direction aligned away from the user 900 (depicted in FIG. 1).

FIG. 3C depicts a perspective view of an embodiment of the apparatus 100 of FIG. 1.

In accordance with the embodiment as depicted in FIG. 3C, the apparatus 100 further includes a remote control device 108. The remote control device 108 is configured to provide any one of a battery power level indication, an on/off power switch, and/or an operating mode switch configured to switch between various operation modes, a color control switch, an emergency switch, a flashing mode switch, a brightness level switch, and/or a compass.

For instance, an operation mode of the remote control device 108 is such that the light-emitting element 106 changes color of the light that is emitted and/or varies in light brightness and/or changes light flashing mode of operation. Preferably, the remote control device 108 is battery powered (standard batteries or rechargeable batteries). The remote control device 108 may be configured to use an existing auxiliary battery on a charger, and/or a solar recharging device (if so desired), etc. For the case where rechargeable batteries are used, there are three optional charging systems: a wall plug, a car plug and a universal serial bus (USB) port, and any equivalent thereof. Preferably, electrical wiring and batteries are water repellant, etc. In accordance with an option, the remote control device 108 is configured to control the operation of many instances of the apparatus 100 deployed on many workers (users) with a push of a bottom (in case of emergency, etc.). Preferably, the remote control device 108 is configured to cooperate with a BLUE TOOTH (TRADEMARK) network connection (a personal network connection), and any equivalent thereof.

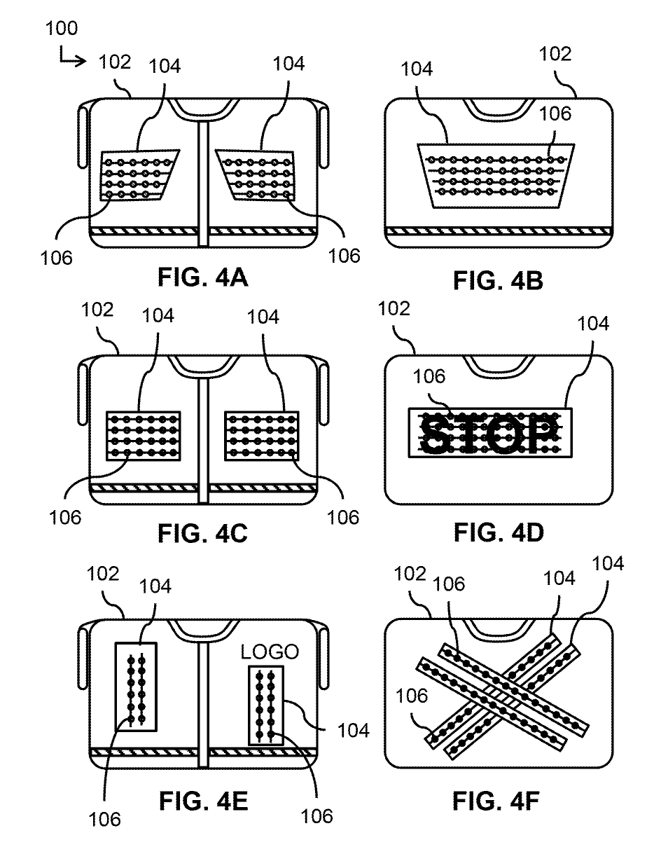

FIGS. 4A to 4F depict views of embodiments of the apparatus 100 of FIG. 1. FIGS. 4A, 4C and 4E depict front views of embodiments of the apparatus 100. FIGS. 4B, 4D and 4F depict rear views of embodiments of the apparatus 100 of FIGS. 4A, 4C and 4E, respectively.

Referring to the embodiments depicted in FIGS. 4A and 4B, the light-reflective element 104 forms centrally positioned sections mounted to the opposite sides of the front side of the garment assembly 102 with instances of the light-emitting element 106 mounted thereto. The light-reflective element 104 also forms a centrally positioned section mounted to the rear side of the garment assembly 102 with the light-emitting element 106 mounted thereto.

Referring to the embodiments depicted in FIGS. 4C and 4D, the light-reflective element 104 forms centrally positioned sections mounted to the opposite sides of the front side of the garment assembly 102 with instances of the light-emitting element 106 mounted thereto. The light-reflective element 104 also forms a centrally positioned section mounted to the rear side of the garment assembly 102 with the light-emitting element 106 mounted thereto. A STOP indication is mounted to the rear side of the garment assembly 102 in such a way that the STOP indication is placed underneath the light-emitting element 106.

Referring to the embodiments depicted in FIGS. 4E and 4F, the light-reflective element 104 forms centrally positioned sections mounted to the opposite sides of the front side of the garment assembly 102 with instances of the light-emitting element 106 mounted thereto. A logo (LOGO) indication is mounted to (such as, on the front section) of the garment assembly 102. The light-reflective element 104 also forms an X shape that is centrally positioned and mounted to the rear side of the garment assembly 102 with the light-emitting element 106 mounted thereto. If so desired, the logo indication includes an LED configured to emit light.

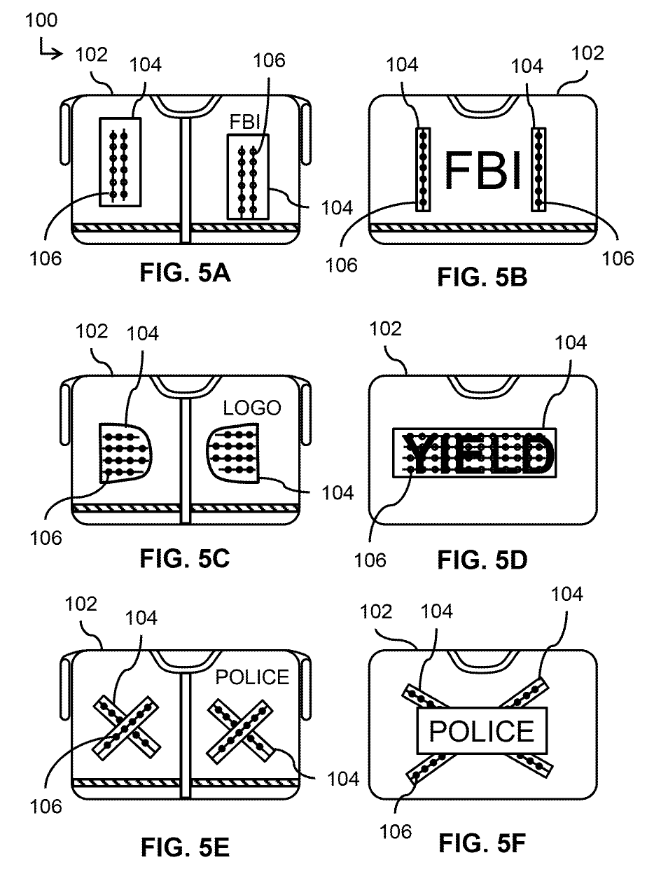

FIGS. 5A to 5F depict views of embodiments of the apparatus 100 of FIG. 1. FIGS. 5A, 5C and 5E depict front views of embodiments of the apparatus 100. FIGS. 5B, 5D and 5F depict rear views of embodiments of the apparatus 100 of FIGS. 5A, 5C and 5E, respectively.

Referring to the embodiments depicted in FIGS. 5A and 5B, the light-reflective element 104 forms centrally positioned sections mounted to the opposite sides of the front side of the garment assembly 102 with instances of the light-emitting element 106 mounted thereto. A LOGO indication (such as, FBI) is mounted on the front section of the garment assembly 102. The light-reflective element 104 forms centrally positioned sections mounted to the opposite sides of the front side of the garment assembly 102 with a LOGO mounted between the centrally positioned sections mounted (formed) on the rear section of the garment assembly 102.

Referring to the embodiments depicted in FIGS. 5C and 5D, the light-reflective element 104 forms centrally positioned sections mounted to the opposite sides of the front side of the garment assembly 102 with instances of the light-emitting element 106 mounted thereto. The light-reflective element 104 also forms a centrally positioned section mounted to the rear side of the garment assembly 102 with the light-emitting element 106 mounted thereto. A YIELD indication is mounted to the rear side of the garment assembly 102 in such a way that the YIELD indication is placed underneath the light-emitting element 106.

Referring to the embodiments depicted in FIGS. 5E and 5F, the light-reflective element 104 forms centrally positioned X-shaped sections mounted to the opposite sides of the front side of the garment assembly 102 with instances of the light-emitting element 106 mounted thereto. The light-reflective element 104 also forms a centrally positioned X-shaped section mounted to the rear side of the garment assembly 102 with the light-emitting element 106 mounted thereto. A POLICE indication is mounted to the rear side of the garment assembly 102 in such a way that the POLICE indication is placed underneath the light-emitting element 106.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a garment assembly;
a light-reflective element being mounted to the garment assembly; and
a light-emitting element being configured to be mounted to the garment assembly relative to the light-reflective element.

2. An apparatus for a user, the apparatus comprising:
a garment assembly being configured to be worn by the user;
a light-reflective element being mounted to the garment assembly, and the light-reflective element being configured to receive light having many frequencies, and the light-reflective element also being configured to reflect, in use and at least in part, the light having many frequencies along a direction that is aligned away from the garment assembly; and
a light-emitting element being configured to:
emit a light in response to an application of electrical energy to the light-emitting element;
be mounted to the garment assembly relative to the light-reflective element; and
be positioned, once mounted just so, proximate to the light-reflective element in such a way that some of the light that is emitted by the light-emitting element is reflected by the light-reflective element along the direction that is aligned away from the garment assembly.

3. The apparatus of claim 2, wherein:
the garment assembly is configured to be worn on an upper half of the body of the user.

4. The apparatus of claim 2, wherein:
the garment assembly is configured to provide a built-in pocket configured to receive and support a cell phone.

5. The apparatus of claim 2, wherein:
the garment assembly is made of a fire retardant material.

6. The apparatus of claim 2, wherein:
the light-reflective element includes a strip of material configured to reflect light.

7. The apparatus of claim 2, wherein:
the light-reflective element includes different colors.

8. The apparatus of claim 2, wherein:
the light-emitting element includes a strip of LEDs.

9. The apparatus of claim 2, wherein:
the light-emitting element includes a ribbon-like strip of surface-mounted light-emitting diodes sewn onto the garment assembly on top of the light-reflective element that is sewn onto the garment assembly.

10. The apparatus of claim 2, wherein:
the light-emitting element includes light-emitting diodes that are bonded in silicone.

11. The apparatus of claim 2, wherein:
the light-emitting element includes a control device on board.

12. The apparatus of claim 2, wherein:
the light-emitting element includes light-emitting diodes that are any one of multi-colored light-emitting diodes and single colored light-emitting diodes.

13. The apparatus of claim 2, wherein:
the light-emitting element includes light-emitting diodes that are surface mounted light-emitting diodes.

14. The apparatus of claim 2, wherein:
the light-emitting element and the light-reflective element are positioned on the front side of the garment assembly, at opposite sides of the garment assembly proximate to the arms of the user; and
the light-emitting element and the light-reflective element are positioned on a rear side of the garment assembly in such a way that the light-emitting element and the light-reflective element form an X-pattern that is positioned at a central portion of the rear of the garment assembly.

15. The apparatus of claim 2, further comprising:
a logo indication mounted to of the garment assembly; and
the logo indication includes an LED configured to emit light.

16. The apparatus of claim 2, further comprising:
a remote control device configured to provide any one of a battery power level indication, an on/off power switch, and/or an operating mode switch configured to switch between various operation modes, a color control switch, an emergency switch, a flashing mode switch, a brightness level switch, and/or a compass.

17. The apparatus of claim 2, further comprising:
a remote control device configured to control operation of instances of the apparatus.

18. The apparatus of claim 2, wherein:
the light-reflective element forms centrally positioned sections mounted to opposite sides of the front side of the garment assembly with instances of the light-emitting element mounted thereto; and
the light-reflective element also forms a centrally positioned section mounted to a rear side of the garment assembly with the light-emitting element mounted thereto.

19. The apparatus of claim 2, wherein:
the light-reflective element forms centrally positioned sections mounted to opposite sides of the front side of the garment assembly with instances of the light-emitting element mounted thereto; and
the light-reflective element also forms a centrally positioned section mounted to a rear side of the garment assembly with the light-emitting element mounted thereto.

20. The apparatus of claim 2, further comprising:
an indication is mounted to the rear side of the garment assembly in such a way that the indication is placed underneath the light-emitting element.
